(19) United States
(12) Patent Application Publication
(10) Pub. No.: US 2004/0086831 A1
(43) Pub. Date: May 6, 2004

(54) Detachable architecture of false teeth

(76) Inventor: Yen-Ping Lai, TaiChung City (TW)

Correspondence Address: BIRCH STEWART KOLASCH & BIRCH, PO BOX 747, FALLS CHURCH, VA, 22040-0747, US

(21) Appl. No.: 10/288,414

(22) Filed: Nov. 6, 2002

(51) Int. Cl. A61C 13/12

(52) U.S. Cl. 433/183

(57) ABSTRACT

A detachable architecture of false teeth is comprised of a fixed denture base, a detachable denture base, and a fixing device, in which the fixed denture base is provided with a bridge at its bottom edge and a plurality of hollow fixing caps is consecutively disposed on the bridge for clothing onto normal healthy teeth. Also, at least a retaining seat for securing the detachable denture base is formed in the fixed denture base such that a denture with false teeth will be accommodated in that retaining seat. In addition, for preventing the detachable denture base and the fixed denture base from being dropped away when occluding, a tooth skirt shaped as a flat piece is hence arranged protrusively on two respective sides at a front portion of the bottom edge of the detachable denture base for choking the detachable denture base stably at healthy teeth's roots.

### FIELD OF THE INVENTION

This invention relates to an architecture of false teeth, and more particular to a detachable architecture of false teeth.

### BACKGROUND OF THE INVENTION

A partial denture is so far installed or grown by way of tooth insertion or vegetation, in which the latter would depend on some specified factors for performance other than its considerable expense on the other hand, irrespective of a merit of not causing destructive grinding harm to neighbor teeth, therefore, most people would prefer the former to the latter. The way by insertion is somewhat unconstrained for mounting a false tooth, however, two neighboring healthy teeth have to be ground for accommodating a set of denture, namely, for receiving a false tooth, two extra teeth must be sacrificed to some extent that inevitably makes a patient suffer from a throbbing pain when grinding.

In considering the mentioned defects, this invention has made every endeavor to try providing a better alternative for installing a false tooth or denture.

### SUMMARY OF THE INVENTION

The primary objective of this invention is to provide a detachable architecture of false teeth that offers a patient with ease in denture installation without needing grinding of neighboring healthy teeth. The detachable architecture of false teeth is comprised of a fixed denture base, a detachable denture base, and a fixing device, in which the fixed denture base is provided with a bridge at its bottom edge and a plurality of hollow fixing caps is consecutively disposed on the bridge for clothing onto normal healthy teeth. Also, at least a retaining seat for securing the detachable denture base is formed in the fixed denture base such that a denture with false teeth will be accommodated in that retaining seat. In addition, for preventing the detachable denture base together with the fixed denture base from being dropped away when occluding, a tooth skirt shaped as a flat piece is hence arranged protrusively on two sides respectively at a front portion of the bottom edge of the detachable denture base for choking the detachable denture base stably at healthy teeth's roots.

The merits of this invention might be summarized as:

1. No destructive grinding of any healthy tooth would be required;

2. A patient wouldn't suffer from any throbbing ache during installation of this invention; and

3. As the denture architecture of this invention can be detached easily when and where, personal oral health can be well maintained.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a three-dimensional view of this invention;

FIG. 2 is a three-dimensional exploded view of this invention;

FIG. 3 shows embodiment 1 of this invention;

FIG. 4 shows embodiment 2 of this invention;

FIG. 5 shows embodiment 3 of this invention; and

FIG. 6 shows embodiment 4 of this invention.

### DETAILED DESCRIPTION OF THE INVENTION

An embodiment is provided hereunder for people to look into the architecture and characteristics of this invention.

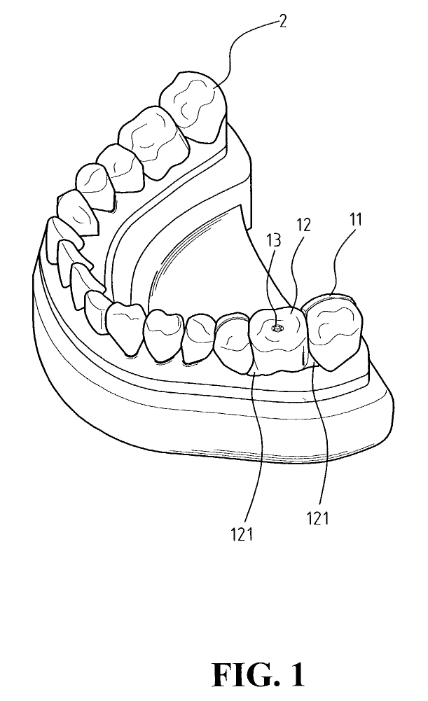

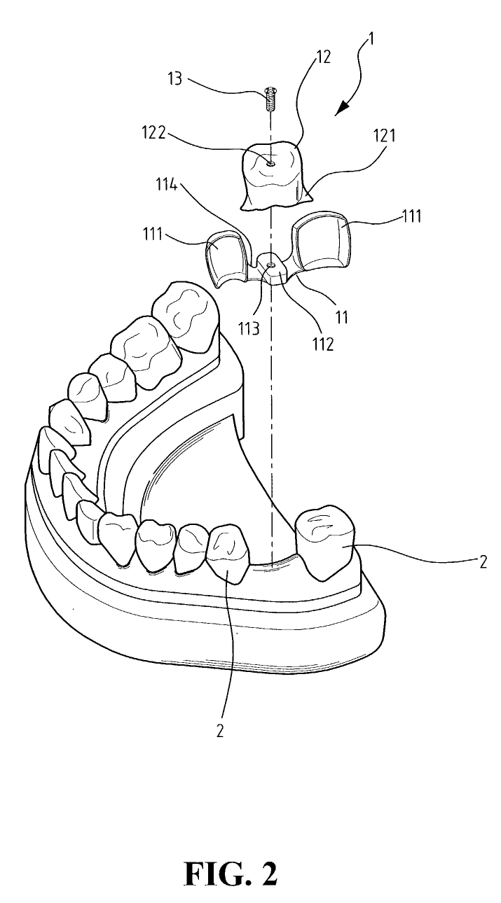

As in a three-dimensional view shown in FIG. 1 and an exploded view shown in FIG. 2, a detachable architecture of false teeth (1) is comprised of a fixed denture base (11), a detachable denture base (12), and a fixing device (13). In the bottom edge of the fixed denture base (11), a bridge (114) is formed and connected with a plurality of fixing caps (111), which is hollow-shaped and half-closed according to a preferred embodiment of this invention, such that a normal healthy tooth (2) can be capped accordingly. The constitution of the fixing caps (111) together with the bridge (114) in the fixed denture base (11) also provides at least a retaining seat (112) for fitting and securing a single false tooth or a detachable denture base (12). Moreover, a master fixing-hole (113) and a slave fixing-hole (122) are formed in the retaining seat (112) and the detachable denture base (12) respectively so that the detachable denture base (12) can be locked to the fixed denture base (11) by penetrating the fixing device (13) through and screwed in both fixing holes (113/122). In addition, for preventing the detachable denture base (12) together with the fixed denture base (11) from being dropped away when occluding, a tooth skirt (121) shaped as a flat piece is hence arranged protrusively on two sides respectively at a front portion of the bottom edge of the detachable denture base (12).

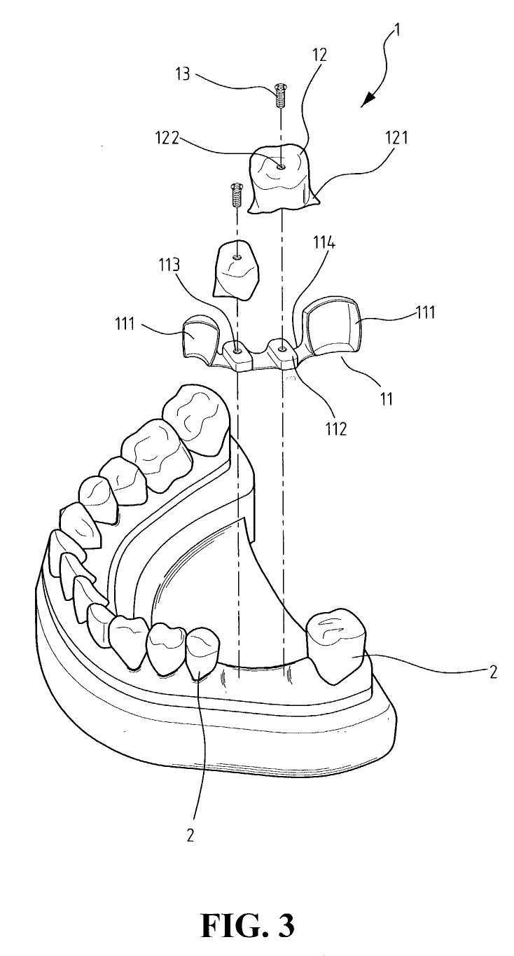

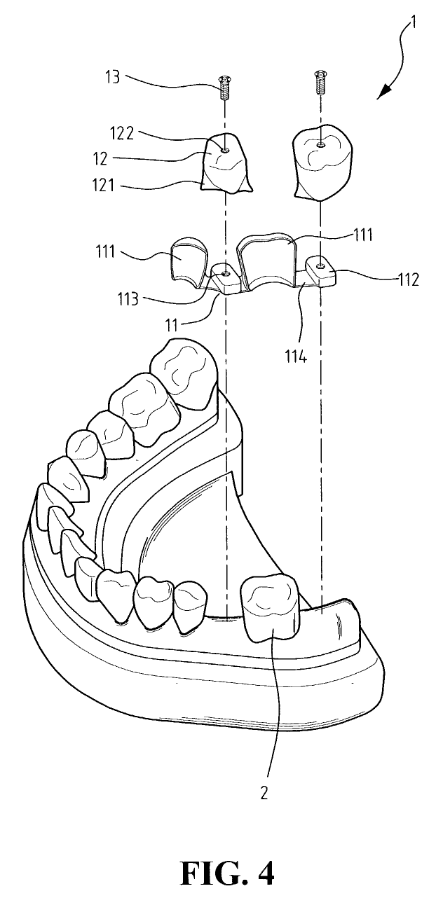

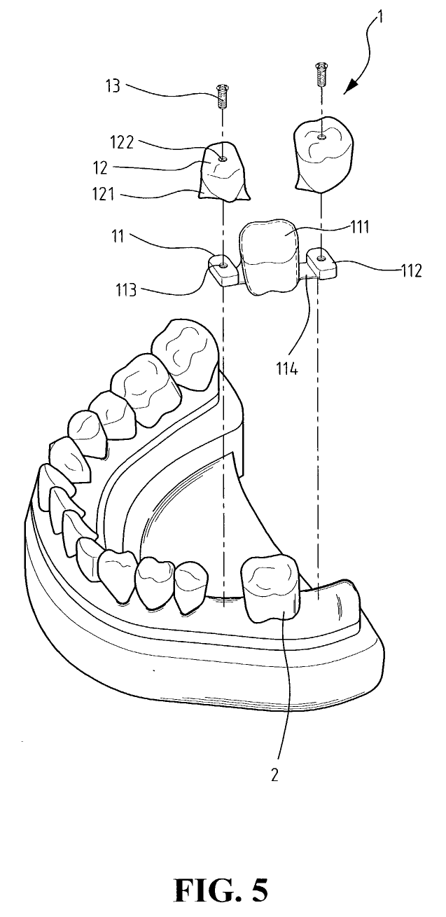

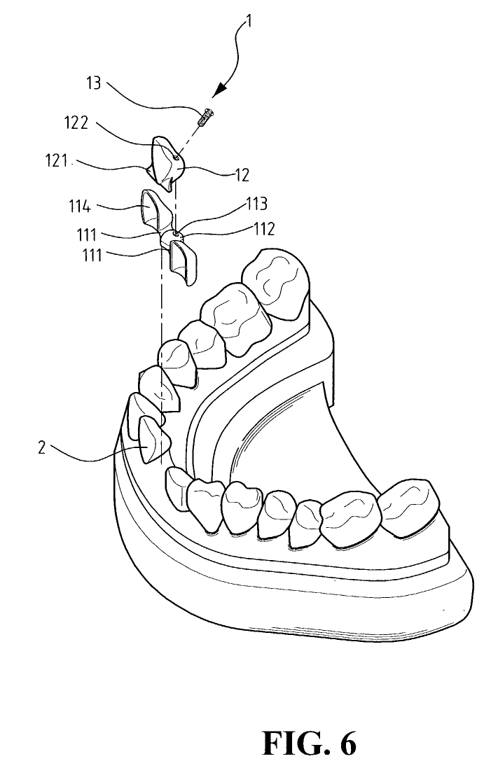

FIGS. 3 through 6 show respective embodiments from embodiment 1 all the way up to embodiment 4. As indicated in those figures, a detachable architecture of false teeth is mainly comprised of a fixed denture base (11), a detachable denture base (12), and a fixing device (13), in which a bridge (114) is disposed at the bottom edge of the fixed denture base (11); at least one fixing cap (111) is arranged on the bridge (114) at center or some proper positions thereof; and the fixing cap might be built in a half-closed or a full-closed configuration. Besides, a plurality of retaining seat (112) in the same amount with that of the detachable denture base (12) could be arranged on the bridge (114) if desired, and also, a single tooth skirt (121) adjacent to a healthy tooth (2) or two might be provided at a front edge on the bottom of the detachable denture base (12) for choking the denture base at a healthy tooth's root.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A detachable architecture of false teeth, comprising:
a fixed denture base having a bridge disposed at a bottom edge thereof, the bridge being provided with a plurality of consecutively positioned hollow fixing caps for clothing onto healthy teeth, and at least a retaining seat being formed accordingly by the instrumentality of the combination of the fixing caps and the bridge for securing a detachable denture base;
a detachable denture base being formed in the shape according to a healthy tooth for fitting in the retaining seat of said fixed denture base and stably fixed by a fixing device, and a tooth skirt being arranged at a front edge of the bottom of said detachable denture base; and
a fixing device being applied for combining said detachable denture base to said fixed denture base.

2. The detachable architecture of false teeth according to claim 1, in which said fixing cap is built in a half-closed or a full-closed configuration.

3. The detachable architecture of false teeth according to claim 1, in which a master fixing-hole is formed in said retaining seat.

4. The detachable architecture of false teeth according to claim 1, in which a slave fixing-hole is formed in said detachable denture base.

5. The detachable architecture of false teeth according to claim 1, in which a tooth skirt is disposed at two respective sides of a front edge on the bottom of said detachable denture base, or only a single tooth skirt is required and arranged leaning against one side of a healthy tooth depending on situations.
